(19) United States
(12) Patent Application Publication
(10) Pub. No.: US 2018/0317111 A1
(43) Pub. Date: Nov. 1, 2018

(54) CACHING POSITIONING MEASUREMENT REPORTS

(71) Applicant: QUALCOMM Incorporated, San Diego, CA (US)

(72) Inventors: Hem Agnihotri, Varanasi (IN); Anurag Tiwari, Hardoi (IN); Bapineedu Chowdary Gummadi, Hyderabad (IN); Venkata A Naidu Babbadi, Hyderabad (IN)

(21) Appl. No.: 15/582,690

(22) Filed: Apr. 30, 2017

(51) Int. Cl. H04W 24/10; H04W 64/00; H04W 24/08; G01S 5/02

(52) U.S. Cl. CPC H04W 24/10; H04W 64/00; G01S 5/0252; G01S 5/0236; H04W 24/08

(57) ABSTRACT

Techniques are disclosed for optimizing performance of positioning measurements. In an aspect, a wireless mobile device receives a positioning measurements request indicating a plurality of cells of a cellular network to be measured by the wireless mobile device, and, for each cell of the plurality of cells having an entry in a memory of the wireless mobile device: based on an indicator indicating that previous positioning measurements for the cell are valid, retrieves the previous positioning measurements for the cell from the memory of the wireless mobile device and sends the previous positioning measurements for the cell to the location server, and, based on the indicator indicating that the previous positioning measurements for the cell are not valid, performs new positioning measurements for the cell and sends the new positioning measurements for the cell to the location server.

### BACKGROUND

### 1. Field of the Disclosure

Aspects relate to caching positioning measurement reports.

### 2. Description of the Related Art

Many wireless mobile devices, such as cellular phones, wearable devices (e.g., smart watches, health wrist bands, etc.), tablet computers, etc., are not always moving. For example, at night, a user may keep his or her cellular phone and smart watch on the night stand until the next morning. In addition, there are many enhanced machine-type communication (e-MTC) devices (a.k.a. Internet of Things (IOT) devices) that may be static in nature, such as smart appliances, smart meters, etc., and thus the position of these devices does not change often.

Currently, even if a device has not moved, such a device will still perform positioning measurement (e.g., Positioning Reference Signal (PRS) measurements) in response to every request from the location server, even though all measurement results will remain the same. These measurements are costly and can drain the battery, which is of great importance for battery-operated devices, such as wireless mobile devices and IOT devices.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for optimizing performance of positioning measurements includes receiving, at a wireless mobile device, a positioning measurements request indicating a plurality of cells of a cellular network to be measured by the wireless mobile device, and, for each cell of the plurality of cells having an entry in a memory of the wireless mobile device: retrieving, by the wireless mobile device, based on an indicator indicating that previous positioning measurements for the cell are valid, the previous positioning measurements for the cell from the memory of the wireless mobile device and sending the previous positioning measurements for the cell to the location server, and performing, by the wireless mobile device, based on the indicator indicating that the previous positioning measurements for the cell are not valid, new positioning measurements for the cell and sending the new positioning measurements for the cell to the location server.

In an aspect, an apparatus for optimizing performance of positioning measurements includes a transceiver of a wireless mobile device configured to receive a positioning measurements request indicating a plurality of cells of a cellular network to be measured by the wireless mobile device, and at least one processor configured to, for each cell of the plurality of cells having an entry in a memory of the wireless mobile device: retrieve, based on an indicator indicating that previous positioning measurements for the cell are valid, the previous positioning measurements for the cell from the memory of the wireless mobile device and send the previous positioning measurements for the cell to the location server; and perform, based on the indicator indicating that the previous positioning measurements for the cell are not valid, new positioning measurements for the cell and send the new positioning measurements for the cell to the location server.

In an aspect, a non-transitory computer-readable medium storing computer-executable instructions for optimizing performance of positioning measurements includes computer-executable instructions comprising at least one instruction to cause a wireless mobile device to receive a positioning measurements request indicating a plurality of cells of a cellular network to be measured by the wireless mobile device, and at least one instruction to cause the wireless mobile device to, for each cell of the plurality of cells having an entry in a memory of the wireless mobile device: retrieve, based on an indicator indicating that previous positioning measurements for the cell are valid, the previous positioning measurements for the cell from the memory of the wireless mobile device and send the previous positioning measurements for the cell to the location server, and perform, based on the indicator indicating that the previous positioning measurements for the cell are not valid, new positioning measurements for the cell and send the new positioning measurements for the cell to the location server.

In an aspect, an apparatus for optimizing performance of positioning measurements includes means for receiving, at a wireless mobile device, a positioning measurements request indicating a plurality of cells of a cellular network to be measured by the wireless mobile device, and, for each cell of the plurality of cells having an entry in a memory of the wireless mobile device: means for retrieving, based on an indicator indicating that previous positioning measurements for the cell are valid, the previous positioning measurements for the cell from the memory of the wireless mobile device and sending the previous positioning measurements for the cell to the location server, and means for performing, based on the indicator indicating that the previous positioning measurements for the cell are not valid, new positioning measurements for the cell and sending the new positioning measurements for the cell to the location server.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates an exemplary mobile device that may be used in an operating environment that can determine position using wireless techniques, according to one aspect of the disclosure.

FIG. 3 illustrates a conventional Long-Term Evolution (LTE) Positioning Protocol (LPP) call flow between the wireless mobile device and the location server for performing positioning operations.

FIG. 4 illustrates an exemplary system for caching positioning measurement reports according to at least one aspect of the disclosure.

FIG. 5 illustrates an exemplary flow for optimizing performance of positioning measurements according to at least one aspect of the disclosure.

FIG. 6 is a simplified block diagram of several sample aspects of an apparatus configured to support communication as taught herein.

### DETAILED DESCRIPTION

Techniques are disclosed for optimizing performance of positioning measurements. In an aspect, a wireless mobile device receives a positioning measurements request indicating a plurality of cells of a cellular network to be measured by the wireless mobile device, and, for each cell of the plurality of cells having an entry in a memory of the wireless mobile device: based on an indicator indicating that previous positioning measurements for the cell are valid, retrieves the previous positioning measurements for the cell from the memory of the wireless mobile device and sends the previous positioning measurements for the cell to the location server, and, based on the indicator indicating that the previous positioning measurements for the cell are not valid, performs new positioning measurements for the cell and sends the new positioning measurements for the cell to the location server.

These and other aspects of the disclosure are disclosed in the following description and related drawings directed to specific aspects of the disclosure. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A client device, referred to herein as a wireless mobile device, may communicate with a wired access network and/or a radio access network (RAN). As used herein, the term “wireless mobile device” may be referred to interchangeably as a “user equipment” or “UE,” an “access terminal” or “AT,” a “wireless device,” a “subscriber device,” a “subscriber terminal,” a “subscriber station,” a “user terminal” or UT, a “mobile device,” a “mobile terminal,” a “mobile station” and variations thereof. In an aspect, wireless mobile devices can communicate with a core network via the RAN, and through the core network the wireless mobile devices can be connected with external networks such as the Internet. Of course, other mechanisms of connecting to the core network and/or the Internet are also possible for the wireless mobile devices, such as over wired access networks, WiFi networks (e.g., based on Institute of Electrical and Electronics Engineers (IEEE) 802.11, etc.) and so on. Wireless mobile devices can be embodied by any of a number of types of devices including but not limited to cellular telephones, personal digital assistants (PDAs), pagers, laptop computers, tablet computers, desktop computers, wearable devices, “smart” appliances, monitoring devices, metering devices, printed circuit (PC) cards, compact flash devices, external or internal modems, wireless or wireline phones, and so on.

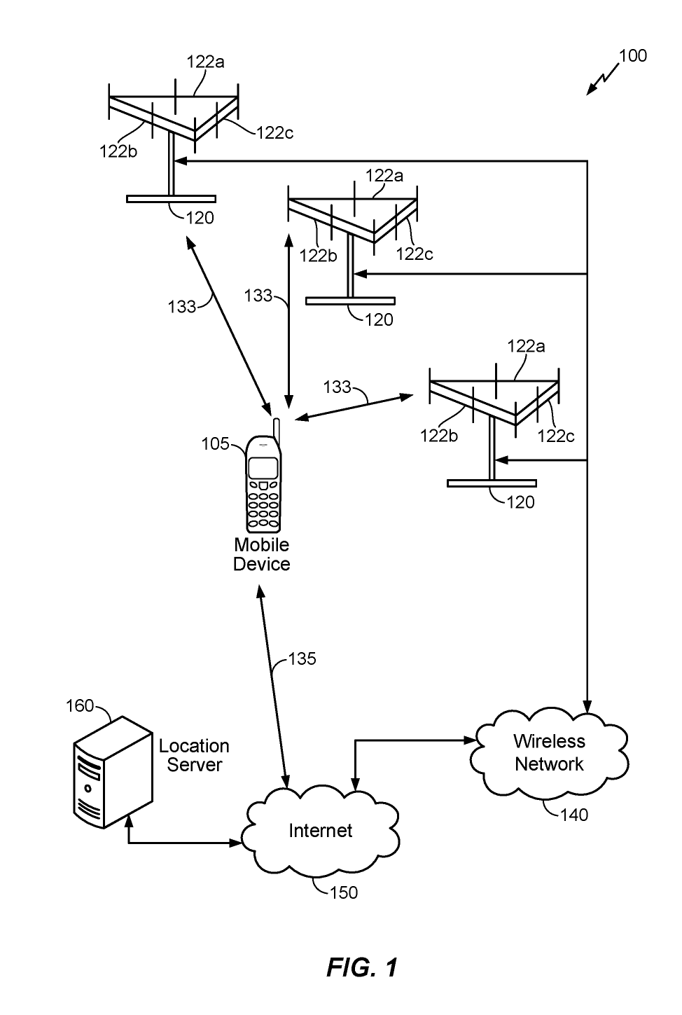

A wireless wide area network (WWAN), such as a cellular network, can utilize mobile telecommunication cellular network technology to enable wireless mobile devices, such as cellular phones, tablet computers, laptop computers, personal digital assistants (PDAs), and/or other mobile wireless devices, to transmit and receive data over a large geographical region using cell towers or base stations. FIG. 1 is a simplified illustration of a WWAN 100 capable of implementing the techniques described herein, according to at least one aspect of the disclosure. The WWAN 100 can include at least one wireless mobile device 105, a wireless network 140, base stations 120 (which, in LTE, are referred to as “evolved Node Bs,” “eNode Bs,” or “eNBs”), a location server 160 (which, in LTE, may be an Enhanced Serving Mobile Location Center (E-SMLC) or a Secure User Plane Location (SUPL) Location Platform (SLP)), and the Internet 150. As illustrated in FIG. 1, each base station 120 includes three arrays of antennas 122a, 122b, and 122c. Each antenna array 122a, 122b, and 122c may include one or more antennas. Each antenna array 122a, 122b, and 122c corresponds to a “cell” of each base station 120 that can provide cellular connectivity to wireless mobile devices 105 within its coverage area. The base stations 120 may utilize a given cellular communications protocol (e.g., Code Division Multiple Access (CDMA), Evolution-Data Optimized (EV-DO), Enhanced High Rate Packet Data (eHRPD), Global System for Mobile communications (GSM), Enhanced Data rates for GSM Evolution (EDGE), Wideband CDMA (W-CDMA), Long-Term Evolution (LTE), etc.) to communicate with the wireless mobile devices 105 within their coverage area.

It should be noted that FIG. 1 provides only a generalized illustration of various components, any or all of which may be utilized as appropriate, and each of which may be duplicated as appropriate for any given implementation. For example, although only one wireless mobile device 105 is illustrated, it will be understood that many wireless mobile devices (e.g., hundreds, thousands, millions, etc.) may be utilized in the WWAN 100. Similarly, WWAN 100 may include many more base stations 120 than the three shown in FIG. 1. Even so, some aspects may have fewer base stations 120. Further, although base stations 120 are illustrated as having three arrays of antennas (and thus three “cells”) forming a triangle, it will be appreciated that there may be more or fewer arrays of antennas and/or the arrays of antennas may be arranged in different shapes. Furthermore, components may be rearranged, combined, separated, substituted, and/or omitted, depending on the desired functionality. A person of ordinary skill in the art will recognize many modifications to the components illustrated.

The base stations 120 can be linked to certain geographic locations, and therefore, can be utilized to enable positioning of the wireless mobile device 105. Such positioning may be used, for example, as a complement and/or an alternative to other positioning technologies (e.g., Satellite Positioning System (SPS)). The positioning of the wireless mobile device 105 using base stations 120 may be based on measurements that are indicative of the distance between the wireless mobile device 105 and the base stations 120. For example, each antenna array 122a, 122b, and 122c of the base stations 120 may be configured to transmit radio frequency (RF) reference signals (such as cell-specific reference signals (CRS) and/or positioning reference signals (PRS)) to nearby wireless mobile devices 105 to enable the wireless mobile devices 105 to take measurements of RF signal timing differences between pairs of cells (that is, measurements are based on RF signals received from two of antenna arrays 122a, 122b, or 122c of a first base station 120, or based on RF signals received from one of antenna arrays 122a, 122b, or 122c of a first base station 120 and one of antenna arrays 122a, 122b, or 122c of a different base station 120). The wireless mobile device 105 can either calculate an estimate of its position based on these timing difference measurements, or send the measurements to the location server 160 using, for example, Observed Time Difference of Arrival (OTDOA) positioning techniques (e.g., Long-Term Evolution (LTE) Positioning Protocol) to enable the location server 160 to estimate the position of the wireless mobile device 105.

The base stations 120 are communicatively coupled to the wireless network 140 (e.g., a cellular network), which may be communicatively coupled with the Internet 150. The location server 160 can also be communicatively coupled with the Internet 150. Thus, the wireless mobile device 105 can communicate the timing difference measurements and/or an estimated location to the location server 160 via the Internet 150 and/or other data communication network via a first communication link 133 to one or more base stations 120 and/or by accessing the Internet 150 via a second communication link 135 (e.g., a wireless local area network (WLAN), such as a WiFi network). Although not illustrated in FIG. 1, the second communication link 135 may comprise a wireless link between the wireless mobile device 105 and a wireless access point and a wired or wireless backhaul link between the wireless access point and the Internet 150.

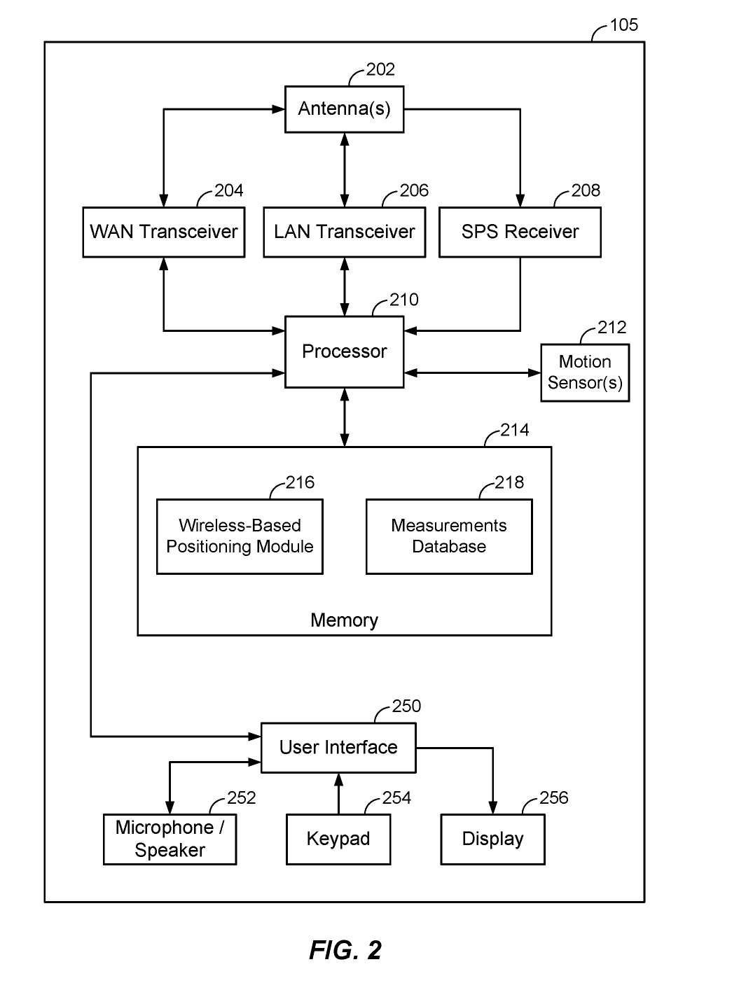

FIG. 2 is a block diagram illustrating various components of the exemplary wireless mobile device 105. For the sake of simplicity, the various features and functions of the wireless mobile device 105 illustrated in FIG. 2 are connected together using a common bus that is meant to represent that these various features and functions are operatively coupled together. Those skilled in the art will recognize that other connections, mechanisms, features, functions, or the like, may be provided and adapted as appropriate to operatively couple and configure an actual wireless mobile device. Further, it is also recognized that one or more of the features or functions illustrated in the example of FIG. 2 may be further subdivided or two or more of the features or functions illustrated in FIG. 2 may be combined.

The wireless mobile device 105 may include one or more wide area network (WAN) transceivers (illustrated in FIG. 2 as one WAN transceiver 204) that may be connected to one or more antennas 202. The WAN transceiver 204 comprises suitable devices, hardware, and/or software for communicating with and/or detecting signals to/from one or more antenna arrays 122a, 122b, and/or 122c of base stations 120, and/or directly with other wireless mobile devices within a network. For example, in an aspect, the WAN transceiver 204 may be configured to receive a positioning measurements request indicating a plurality of cells of a cellular network to be measured by the wireless mobile device 105, as described further herein. In one aspect, the WAN transceiver 204 may comprise a CDMA communication system suitable for communicating with a CDMA network of wireless base stations (e.g., base stations 120); however, in other aspects, the wireless communication system may comprise another type of cellular telephony network, such as, for example, Time Division Multiple Access (TDMA) or GSM. Additionally, any other type of wide area wireless networking technologies may be used, for example, WiMAX (IEEE 802.16), etc.

The wireless mobile device 105 may also include one or more local area network (LAN) transceivers (illustrated in FIG. 2 as one LAN transceiver 206) that may be connected to the one or more antennas 202. The LAN transceiver 206 comprises suitable devices, hardware, and/or software for communicating with and/or detecting signals to/from a WLAN access point, for example, and/or directly with other wireless mobile devices within a network. In an aspect, the LAN transceiver 206 may comprise a Wi-Fi (IEEE 802.11x) communication system suitable for communicating with one or more WLAN wireless access points; however, in other aspects, the LAN transceiver 206 may comprise another type of local area network, personal area network (e.g., Bluetooth®), etc. Additionally, any other type of wireless networking technologies may be used, for example, Ultra Wide Band, ZigBee®, wireless Universal Serial Bus (USB), etc.

A Satellite Positioning System (SPS) receiver 208 may also be included in the wireless mobile device 105. The SPS receiver 208 may be connected to the one or more antennas 202 for receiving satellite signals. The SPS receiver 208 may comprise any suitable hardware and/or software for receiving and processing SPS signals. The SPS receiver 208 requests information and operations as appropriate from the other systems, and performs the calculations for determining the wireless mobile device's 105 position using measurements obtained by any suitable SPS algorithm.

Motion sensor(s) 212 (which may include one or more motion sensors) may be coupled to a processor 210 to provide movement and/or orientation information that is independent of motion data derived from signals received by the WAN transceiver 204, the LAN transceiver 206, and/or the SPS receiver 208. By way of example, the motion sensor(s) 212 may include an accelerometer (e.g., a microelectromechanical systems (MEMS) device), a gyroscope, a geomagnetic sensor (e.g., a compass), an altimeter (e.g., a barometric pressure altimeter), and/or any other type of movement detection sensor. Moreover, the motion sensor(s) 212 may include a plurality of different types of devices and combine their outputs in order to provide motion information. For example, the motion sensor(s) 212 may use a combination of a multi-axis accelerometer and orientation sensors to provide the ability to compute positions in two-dimensional (2D) and/or three-dimensional (3D) coordinate systems.

The processor 210 may be connected to the WAN transceiver 204, LAN transceiver 206, SPS receiver 208, and motion sensor(s) 212. The processor 210 may include one or more microprocessors, microcontrollers, application-specific integrated circuits (ASICs), and/or digital signal processors (DSPs) that provide processing functions, as well as other calculation and control functionality. The processor 210 may also include or be coupled to a memory 214 for storing data and software instructions for executing programmed functionality within the wireless mobile device 105. The memory 214 may be on-board the processor 210 (e.g., within the same integrated circuit (IC) package), and/or the memory may be external memory to the processor and functionally coupled over a data bus.

A number of software modules and data tables may reside in memory 214 and be utilized by the processor 210 in order to provide the functionality described herein. As illustrated in FIG. 2, memory 214 may include and/or otherwise receive a wireless-based positioning module 216 and a measurements database 218. The wireless-based positioning module 216 may be a process running on the processor 210 of the wireless mobile device 105. As will be described further below, the wireless-based positioning module 216 may derive the position of the wireless mobile device 105 based on measuring signals received from a plurality of access points, such as base stations 120. As will also be described further below, the measurements database 218 stores the results of the most recent positioning measurements taken by the wireless-based positioning module 216 of RF signals transmitted by various antenna arrays 122a, 122b, and/or 122c of base stations 120 and a corresponding bit indicating whether or not those positioning measurements results are valid or invalid. As such, in an aspect, the processor 210 may be configured to, for each cell of the plurality of cells having an entry in the measurements database 218, retrieve, based on an indicator indicating that previous positioning measurements for the cell are valid, the previous positioning measurements for the cell from the memory of the wireless mobile device and send the previous positioning measurements for the cell to a location server 160, and perform, based on the indicator indicating that the previous positioning measurements for the cell are not valid, new positioning measurements for the cell and send the new positioning measurements for the cell to the location server 160.

One should appreciate that the organization of the memory 214 as shown in FIG. 2 is merely exemplary, and as such, the functionality of the modules and/or data structures may be combined, separated, and/or be structured in different ways depending upon the implementation of the wireless mobile device 105. Alternatively, while the modules shown in FIG. 2 are illustrated in the example as being contained in the memory 214, it is recognized that in certain implementations such procedures may be provided for or otherwise operatively arranged using other or additional mechanisms. For example, all or part of the wireless-based positioning module 216 and/or the measurements database 218 may be provided in firmware.

The wireless mobile device 105 may further include a user interface 250 that provides any suitable interface systems, such as a microphone/speaker 252, keypad 254, and display 256 that allows user interaction with the wireless mobile device 105. The microphone/speaker 252 provides for voice communication services using the WAN transceiver 204 and/or the LAN transceiver 206. The keypad 254 comprises any suitable buttons for user input. The display 256 comprises any suitable display, such as, for example, a backlit liquid crystal display (LCD), and may further include a touch screen display for additional user input modes.

As used herein, the wireless mobile device 105 may be any portable or movable device or machine that is configurable to acquire wireless signals transmitted from, and transmit wireless signals to, one or more wireless communication devices or networks. As shown in FIG. 2, the wireless mobile device 105 is representative of such a portable wireless device. Thus, by way of example but not limitation, the wireless mobile device 105 may include a radio device, a cellular telephone device, a computing device, a personal communication system (PCS) device, or other like movable wireless communication equipped device, appliance, or machine. The term “wireless mobile device” is intended to include all devices, including wireless devices, computers, laptops, tablets, etc., that are capable of communication with a location server (e.g., location server 160), such as via the Internet 150, Wi-Fi, or other network. Any operable combination of the above is also considered a “mobile device.”

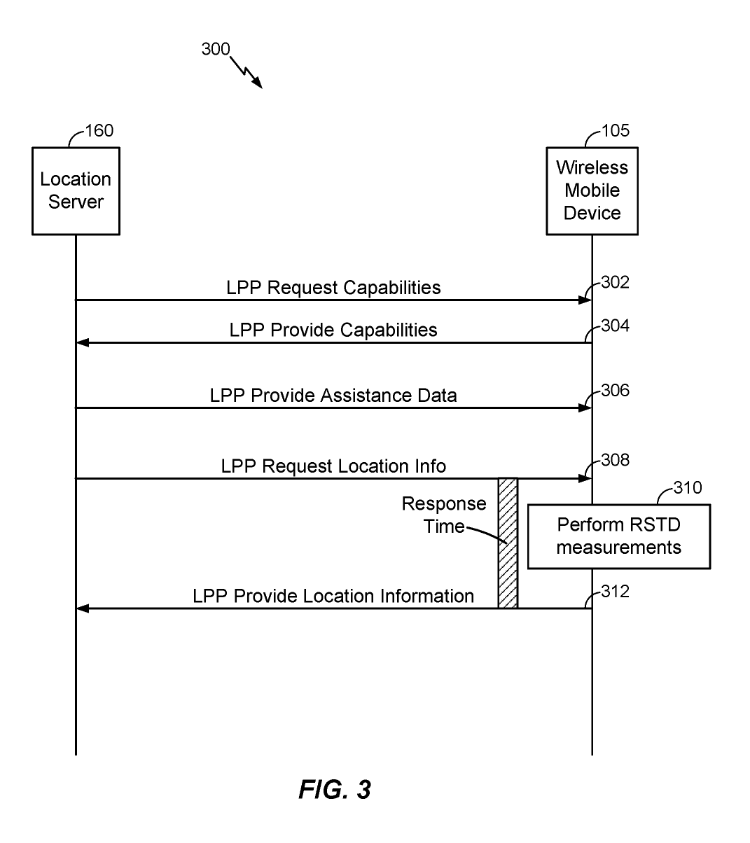

As noted above, the wireless-based positioning module 216 may derive the position of the wireless mobile device 105 based on measuring signals received from a plurality of access points, such as base stations 120. One example of determining the position of the wireless mobile device 105 based on measuring signals received from a plurality of access points is the LTE Positioning Protocol (LPP). FIG. 3 illustrates an LPP call flow 300 between the wireless mobile device 105 and the location server 160 for performing positioning operations. Although described as being performed by the wireless mobile device 105 for simplicity, the flow 300 is performed by execution of the wireless-based positioning module 216 (e.g., by processor 210 where the wireless-based positioning module 216 is an executable software module) causing other components of the wireless mobile device 105 (e.g., processor 210, WAN transceiver 204, etc.) to perform operations and/or processing information from other components of the wireless mobile device 105 (e.g., WAN transceiver 204).

Referring to flow 300, at 302, the location server 160 sends an LPP capabilities request to the wireless mobile device 105. At 304, the wireless mobile device 105 responds with its LPP capabilities. At 306, the location server 160 sends assistance data for LPP positioning operations to the wireless mobile device 105. The assistance data includes information to assist the wireless mobile device 105 to measure reference signals (e.g., CRS or PRS signals) transmitted by a plurality (e.g., 10) of cells (i.e., antenna arrays 122a, 122b, and/or 122c). At 308, the location server 160 sends a request for location information to the wireless mobile device 105. At 310, the wireless mobile device 105 performs positioning signal measurements, i.e., measurements that are indicative of the distance between the wireless mobile device 105 and the base stations 120. For example, in LPP, the wireless mobile device 105 measures the RF signal timing differences between the CRS/PRS signals received from pairs of “cells” identified in the assistance data received from the location server 160, which is referred to in LTE as OTDOA or Reference Signal Time Difference (RSTD). At 312, the wireless mobile device 105 provides its location information (e.g., the RSTD or OTDOA measurements) to the location server 160. The location server 160 can calculate an estimate of the position of the wireless mobile device 105 based on these timing difference measurements. Note that the time between the request for location information at 308 and the response at 312 is the “response time.”

As noted above, many wireless mobile devices, such as cellular telephones, wearable devices (e.g., smart watches, health wrist bands, etc.), tablet computers, etc., are not always moving. For example, at night, a user may keep his or her cellular phone and “smart” watch on the night stand until the next morning. In addition, there are many enhanced machine-type communication (e-MTC) devices (for example, Internet of Things (IoT) devices) that may be static in nature, such as “smart” appliances, “smart” meters, “smart” sensors, etc., and thus the position of these devices does not change often.

Currently, even if the position of a wireless mobile device has not changed, such a device still performs positioning measurements (e.g., RSTD measurements as described above with reference to FIG. 3) in response to every request from the location server 160, even though the measurements results will remain the same. These measurements are costly and can quickly drain the battery of the device, which is of great importance for battery-operated devices, such as wireless mobile devices and IOT devices.

If the position of a wireless mobile device has not changed, such that the measurements results for subsequent positioning requests would be the same, then repeated positioning measurements can be avoided.

Most, if not all, wireless mobile devices, such as wireless mobile device 105, have motion detecting sensors (e.g., motion sensor(s) 212 of FIG. 2), such as at least one accelerometer, at least one gyroscope, etc. These sensors can detect the motion of the wireless mobile device 105 and determine when it starts to move. To prevent repeating positioning measurements, the wireless mobile device 105 can save the most recent positioning measurements results for previously measured cells, and a corresponding bit indicating whether or not the latest positioning measurements results for those cells are valid/invalid, in the measurements database 218. In operation, when the wireless mobile device 105 performs positioning measurements for a cell, such as during the positioning measurements described above with reference to FIG. 3, it stores the results in the measurements database 218 and sets the corresponding valid/invalid bits for the measured cells to “valid.” When the wireless mobile device 105 starts to move, the motion sensor(s) 212 send an indication to invalidate the previously stored positioning measurements results by changing the valid/invalid bits to “invalid.”

When the location server 160 requests the wireless mobile device 105 to perform positioning measurements (e.g., as at 308 of FIG. 3), the wireless mobile device 105 can check the valid/invalid bit in the measurements database 218 corresponding to the previously stored positioning measurements results for the cells indicated in the positioning assistance data received from the location server 160 (e.g., as at 306 of FIG. 3). If a bit for a cell is valid, it means that the wireless mobile device 105 has not moved sufficiently since the last time it performed the positioning measurements for that cell, and the wireless mobile device 105 can send the previous positioning measurements results for that cell to the location server 160 (e.g., as at 312 of FIG. 3), thereby avoiding unnecessary repetition of the positioning measurements. However, if a bit for a cell is invalid, then the wireless mobile device 105 will perform new positioning measurements for that cell (e.g., as at 310 of FIG. 3) and replace the previously stored positioning measurements results in the measurements database 218 with the new results and reset the corresponding bit to “valid.” In other words, after calculating the new positioning measurements for the cell, the wireless mobile device 105 stores the new positioning measurements for the cell in the measurements database 218 and updates the indicator to indicate that the new positioning measurements for the cell are valid.

Note that although a valid/invalid bit has been discussed, any mechanism to indicate whether or not a stored positioning measurements result is valid or invalid can be used, such as a table entry (e.g., including the term “valid” or “invalid”), a registry entry (e.g., including a bit string indicating “valid” or “invalid”), a bitmap (e.g., where each bit in the bitmap corresponds to a cell in the measurements database 218), etc.

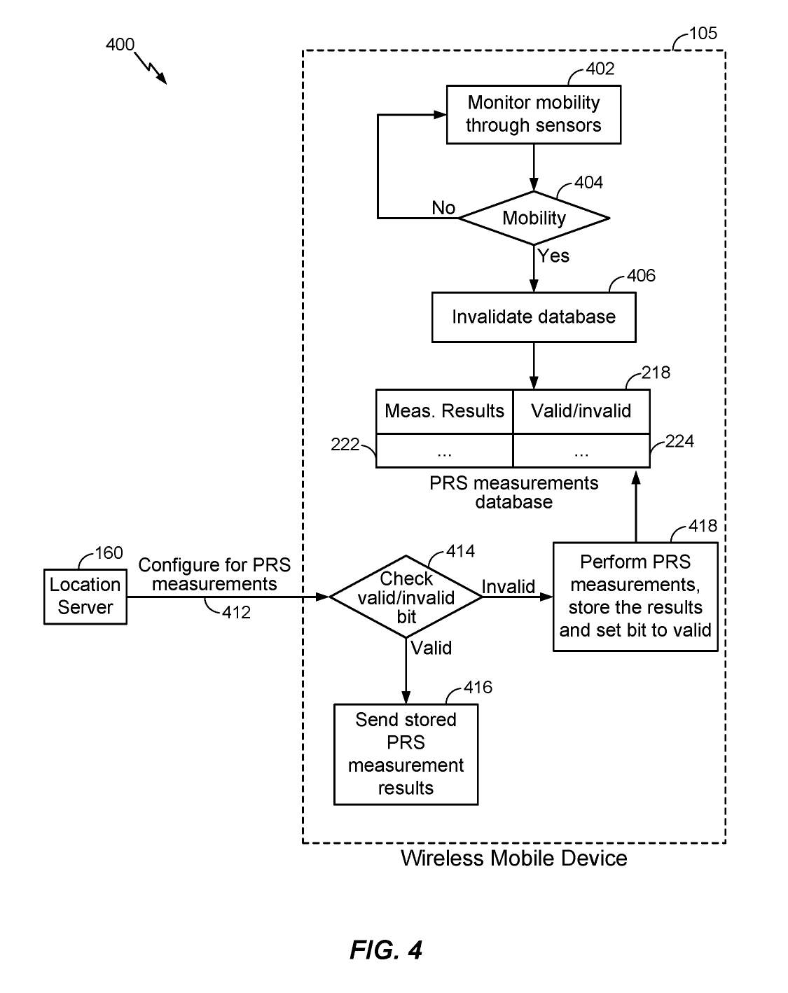

FIG. 4 illustrates an exemplary system 400 for caching positioning measurement reports according to at least one aspect of the disclosure. The system 400 includes a location server 160 and a wireless mobile device 105. The wireless mobile device 105 includes the measurements database 218 that stores, for each previously measured cell, the last/most recent positioning measurements results 222 for that cell and a corresponding bit 224 indicating whether or not the last positioning measurements results 222 are valid or invalid.

At 402, the wireless mobile device 105 (e.g., processor 210 and/or wireless-based positioning module 216) monitors its mobility (i.e., whether or not it is moving or stationary) through motion sensor(s) 212, which may include one or more accelerometers, one or more gyroscopes, etc. At 404, the wireless mobile device 105 (e.g., processor 210 and/or wireless-based positioning module 216) determines whether or not it has moved sufficiently to change any of the measurements results in the measurements database 218. If it has, then at 406, the wireless mobile device 105 (e.g., processor 210 and/or wireless-based positioning module 216) sets the bit 224 for each effected cell to “invalid.” If it has not, the flow returns to 402.

At 412, the wireless mobile device 105 (e.g., WAN transceiver 204) receives a request to perform positioning measurements from the location server 160 (e.g., as at 308 of FIG. 3). In the example of FIG. 4, the positioning measurements may be RSTD measurements of PRS or CRS signals received from a plurality of cells, but the disclosure is not limited to only RSTD measurements. At 414, for each cell in the assistance data received from the location server 160 (e.g., as at 306 of FIG. 3) having an entry in the measurements database 218, the wireless mobile device 105 (e.g., processor 210 and/or wireless-based positioning module 216) checks whether the bit 224 for that cell in the measurements database 218 is “valid” or “invalid.” If it is valid, then at 416, the wireless mobile device 105 (e.g., WAN transceiver 204) sends the stored positioning measurements results 222 for that cell to the location server 160 (e.g., as at 312 of FIG. 3). If, however, the bit 224 is invalid, or an entry for the cell is not present in the measurements database 218, then at 418, the wireless mobile device 105 (e.g., processor 210 and/or wireless-based positioning module 216 in conjunction with the WAN transceiver 204) performs the positioning measurements requested by the location server 160 (e.g., as at 310 of FIG. 3) and returns those measurements to the location server 160 (e.g., as at 312 of FIG. 3). The wireless mobile device 105 (e.g., processor 210 and/or wireless-based positioning module 216) also stores the results of the positioning measurements in the measurements database 218 as the last positioning measurements results 222 for that cell and sets the corresponding bit 224 to valid. It is understood that the positioning measurements (which can be referred to as new positioning measurements since a previous valid positioning measurement is not being used) can comprise PRS measurements. In some implementations, the PRS measurements are based on positioning reference signals transmitted by base stations within wireless communication range of the wireless mobile device 105.

Referring to the measurements database 218 in more detail, although only one entry for positioning measurements results 222 is shown, there may be a plurality of entries corresponding to a plurality of cells of one or more cellular networks that the wireless mobile device 105 has previously measured. In an aspect, the measurements database 218 may include an entry for each cell that the wireless mobile device 105 has ever measured. When the wireless mobile device 105 receives the positioning request at 412, it performs operation 414 and, as appropriate, operation 416 or 418, for each cell indicated in the positioning assistance data received from the location server 160 and having an entry in the measurements database 218. For cells indicated in the positioning assistance data that do not have an entry in the measurements database 218, the wireless mobile device 105 only performs operation 418.

Note that the wireless mobile device 105 need not perform operations 414 to 418 for all cells in the measurements database 218, but rather, for only the cells indicated in the positioning assistance data for the current positioning request received at 412. Further, the positioning assistance data may include information about more cells than the wireless mobile device 105 actually needs to measure and report to the location server 160. For example, the positioning assistance data may include information to enable the wireless mobile device 105 to measure ten cells. However, the positioning assistance data or the positioning request may indicate that the wireless mobile device 105 only needs to return measurements for three cells. In such a situation, if the measurements database 218 does not include entries for all ten cells, but does include entries for at least three of the ten cells, the wireless mobile device 105 may preferentially perform operations 414 to 418 for those three cells, rather than choosing cells it has not previously measured. In a similar scenario, the measurements database 218 may not include valid measurements (e.g., as indicated by bit 224) for all ten cells, but may include valid measurements for at least three of the ten cells. In that case, the wireless mobile device 105 may perform operations 414 and 416 for at least three of the valid cells, rather than unnecessarily performing operation 418 for a cell whose measurements are currently invalid.

Referring in more detail to the determination at 404 of whether or not the wireless mobile device 105 has moved, as noted above, the wireless mobile device 105 performs operation 406, i.e., the determination of whether or not the bit 224 should be set to “invalid,” for each cell in the measurements database 218. More specifically, each entry for a cell in the measurements database 218 may include a measurements-valid threshold for that cell. In response to detecting the movement of the wireless mobile device 105 at 404, for each cell in the measurements database 218, the wireless mobile device 105 compares the detected movement of the wireless mobile device 105 to the measurements-valid threshold for the cell. In response to the comparison indicating that the movement of the wireless mobile device 105 exceeds the measurements-valid threshold for the cell, the wireless mobile device 105 sets the bit 224 for that cell to “invalid.” In other words, the wireless mobile device 105 updates, in response to the comparison indicating that the movement of the wireless mobile device 105 exceeds the measurements-valid threshold, an indicator to indicate that the previous positioning measurements for the cell are invalid.

In an aspect, the measurements-valid threshold for a cell may be a function of both movement of the wireless mobile device 105 and cell parameters detected by the wireless mobile device 105, such as signal to noise ratio (SNR), signal to interference and noise ratio (SINR), received signal strength indication (RSSI), reference signal received quality (RSRQ), and/or reference signal received power (RSRP) of positioning measurements performed by the wireless mobile device 105. The measurements-valid threshold may be dynamically updated based on, for example, a change in the SNR, SINR, RSSI, RSRQ, or RSRP greater than a signal strength threshold for the given type of signal measurement (i.e., SNR, SINR, RSSI, or RSRP). Thus, in an aspect, the measurements-valid threshold may be a function of various cell parameters (e.g., SNR, SINR, RSSI, RSRQ, or RSRP, etc.) of a cell, the distance of the wireless mobile device 105 from the cell, and the distance the wireless mobile device 105 has moved from where it last computed the PRS measurement with respect to that cell. Alternatively, the measurements-valid threshold may be split into multiple thresholds accounting for each factor, such as a first threshold accounting for distance from the cell, a second threshold accounting for motion of the wireless mobile device 105, and a third threshold accounting for signal parameters of the cell.

There may be two scenarios that can trigger the wireless mobile device 105 to re-compute/re-measure PRS signals. In a first scenario, the measurement of PRS signals may be triggered even if the wireless mobile device 105 has not moved. Specifically, even when the wireless mobile device 105 has not moved, or is not moving, signal parameters of the cell (e.g., SINR, RSRP, RSRQ, etc.) can change significantly. For example, this can occur in situations such as rain fading (the absorption of RF signals by atmospheric rain, snow, ice, etc.), high interference (e.g., from other wireless mobile devices 105), etc. As a result of the change(s) in the signal parameters, the measurements-valid threshold can trigger the wireless mobile device 105 to re-compute the PRS measurements even though the wireless mobile device 105 has not actually moved or changed location.

In a second scenario, the measurement of PRS signals may be triggered when the wireless mobile device 105 has moved and the cell parameters detected by the wireless mobile device 105 have changed. When the wireless mobile device 105 is in motion, the wireless mobile device 105 will operate differently depending on whether it is in a good cell coverage area or a bad cell coverage area. If the wireless mobile device 105 is in a good cell coverage area, it means that the wireless mobile device 105 is likely located near the cell, which can be determined by, for example, Event-Al measurement reporting in LTE (that is, the signals from the serving cell are better than a threshold). Small movements at this point likely will not trigger re-computation of PRS for that particular cell, as the cell parameters (e.g., SINR, RSRP, RSRQ, etc.) won't change significantly (e.g., in such a context where cell parameters are stable, the measurements-valid threshold will be relatively higher than in contexts where the cell parameters are unstable, and hence small movements will remain below the measurements-valid threshold).

If, however, the wireless mobile device 105 is in a poor cell coverage area, it means that the wireless mobile device 105 is located near the cell edges, which can be determined by, for example, Event-A2 measurement reporting in LTE (that is, the signals from the serving cell are below a threshold). Thus, a small movement of the wireless mobile device 105 at this point may significantly change the various cell parameters, thereby triggering a hit of the measurements-valid threshold and the re-computation of the PRS measurements.

Thus, as is evident from the foregoing examples, it is beneficial to consider the motion of the wireless mobile device 105 and signal parameters of the cell (e.g., SNR, SINR, RSSI, RSRQ, RSRP, etc.) when determining whether or not to re-compute PRS. In addition, in an aspect, each factor can depend on one or more other factors. For example, if there is a large change in the SNR (e.g., indicating sudden interference), the wireless mobile device 105 can check if it has moved since the last computation of PRS for that cell. Further, in an aspect, the measurements-valid threshold can account for additional factors, such as the type of geographic area (e.g., dense, sparse, etc.), the frequency of operation (e.g., 700 MHz, 2100 MHz, etc.), etc.

As noted above, the validity of previous measurements can be cell dependent. Hence, in one example where the wireless mobile device 105 has positioning measurements stored for three cells, the measurements-valid threshold can be different for each of the three cells. More generally, each cell of the plurality of cells may have a measurements-valid threshold particular to the each cell. As such, a detected movement of the wireless mobile device 105 may not invalidate all positioning measurements results 222 stored in the measurements database 218. Rather, because the cells are located at different geographic locations, the change in the signal (e.g., SNR, SINR, RSSI, or RSRP) will likely not be constant for all of them with respect to the change in movement. As such, a detected movement of the wireless mobile device 105 may invalidate positioning measurements for one or more cells of the plurality of cells while the positioning measurements for the remaining cells of the plurality of cells continue to be valid. Also, in some implementations a measurements-valid threshold may depend on the type of cell each of the plurality of cells is. Hence, for example, for a small cell, the measurements-valid threshold may be based on the size of a coverage area of the small cell, while the measurements-valid threshold for a macro cell could be different. Furthermore, in implementations where the wireless mobile device 105 performs new positioning measurements based on signal parameters of the cell, as just noted relative to the measurements-valid threshold, the mobile device 105 may detect change above a threshold in the signal parameters of one cell and perform new positioning measurements for that cell, while not performing new positioning measurements for another cell whose signal parameters remain stable (e.g., do not change above a threshold).

To illustrate how positioning measurements could be cell dependent, consider a scenario where the wireless mobile device 105 moves around the antenna(s) (e.g., antenna array 122a, 122b, or 122c) of a first cell in a circular fashion, i.e., remaining the same distance from the antenna(s), the signal parameters will likely be constant for that cell, and the wireless mobile device 105 need not perform positioning measurement for that cell. However, the wireless mobile device 105 will likely need to measure other cells in the received positioning assistance data since their signal parameters will likely have changed as the wireless mobile device 105 moves.

As another example, in a scenario where the wireless mobile device 105 is attached to a “small cell” base station (the term “small cell” generally refers to a class of low-powered base stations that may include or be otherwise referred to as femto cells, pico cells, micro cells, etc.) in an indoor venue, such as a house, the wireless mobile device 105 need not measure positioning reference signals from the small cell base station every time the wireless mobile device 105 moves within the venue. However, for nearby “macro cell” base stations (e.g., base stations 120), the wireless mobile device 105 may need to measure positioning reference signals from these cells frequently in response to detecting motion, since, due to the wireless mobile device 105 being indoors, their signal conditions can change drastically due to attenuation, multipath, etc. Note that signal attenuation is dependent on the operating frequency of the cell. The higher the frequency, the higher the attenuation and the lower the coverage range. Thus, for different cells operating on different frequencies, the signal changes will be different.

As yet another example, consider three cells, cell A, cell B, and cell C. If cell C is facing interference when the positioning measurements for this cell are requested by the location server 160, then the wireless mobile device 105 may need to invalidate the previous positioning measurements for the cell even though the wireless mobile device 105 has not moved. This is because, due to interference, the measurements might not have been done correctly or may not be accurate.

Thus, as can be seen from the above, setting/unsetting the bit 224 can be performed independently for the cells in the measurements database 218 due to detected movement of the wireless mobile device 105, a change in a signal characteristic (e.g., SNR, SINR, RSSI, RSRP, etc.) for a given cell where the change indicates a different signaling environment/context for the wireless mobile device 105 that suggests new positioning measurements are appropriate for the given cell, and/or different uncertainties for different cells, which, as described above, may be based on geographic locations, interference, etc.

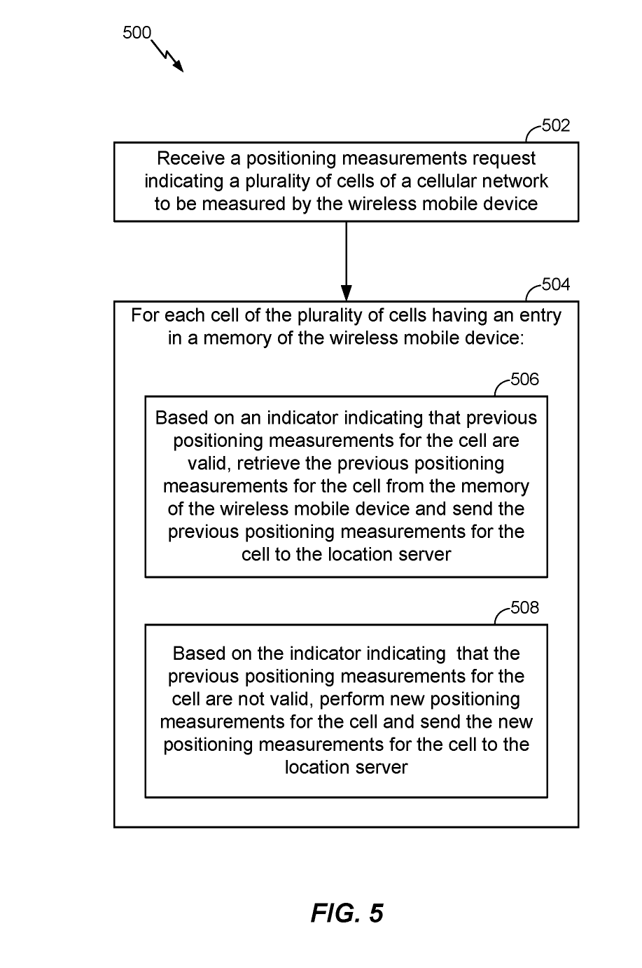

FIG. 5 illustrates an exemplary flow 500 for optimizing performance of positioning measurements according to at least one aspect of the disclosure. The flow 500 may be performed by the wireless mobile device 105.

At 502, the wireless mobile device 105 (e.g., WAN transceiver 204) receives a positioning measurements request (e.g., from the location server 160) indicating a plurality of cells (e.g., corresponding to antenna arrays 122a, 122b, and/or 122c) of a cellular network (e.g., WWAN 100) to be measured by the wireless mobile device 105. At 504, the wireless mobile device 105 performs, for each cell of the plurality of cells having an entry in a memory of the wireless mobile device 105 (e.g., measurements database 218), one of operations 506 and 508.

At 506, based on an indicator (e.g., bit 224) indicating that previous positioning measurements (e.g., measurements results 222) for the cell are valid, the wireless mobile device 105 (e.g., processor 210 and/or wireless-based positioning module 216) retrieves the previous positioning measurements for the cell from the memory of the wireless mobile device 105 and sends the previous positioning measurements for the cell to the location server 160.

Alternatively, at 508, based on the indicator (e.g., bit 224) indicating that the previous positioning measurements (e.g., measurements results 222) for the cell are not valid, the wireless mobile device 105 (e.g., processor 210 and/or wireless-based positioning module 216 in conjunction with WAN transceiver 204) performs new positioning measurements for the cell based on stored information for the cell (e.g., received in positioning assistance data from the location server 160) and sends the new positioning measurements for the cell to the location server 160. As mentioned above, since one of operations 506 or 508 is performed for each cell of the plurality of cells having entry in a memory of the wireless mobile device 105, the wireless mobile device 105 may not perform measurements for a first subset of the plurality of cells responsive to the indicator indicating that the previous positioning measurements are valid while performing measurements for a second subset of the plurality of cells responsive to the indicator indicating that the previous positioning measurements are invalid. Hence, in such a case, the wireless mobile device 105 sends previous positioning measurements to the location server 160 for the first subset of the plurality of cells and performs new positioning measurements for the second subset of the plurality of cells (and subsequently sends the new position measurements to the location server 160 for the second subset of the plurality of cells). It is understood that generally, for a cell not having an entry in a memory of the wireless mobile device 105, new positioning measurements will be performed (since no previous measurement exists in memory) as is appropriate in any particular case.

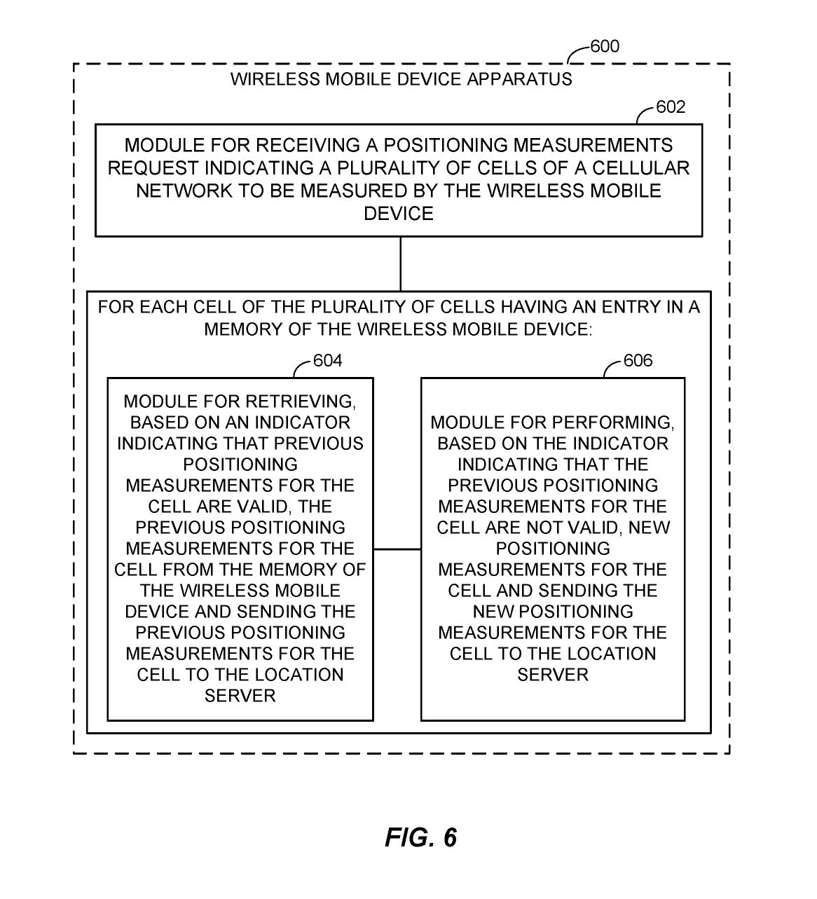

FIG. 6 illustrates an example wireless mobile device apparatus 600 represented as a series of interrelated functional modules. A module for receiving 602 may correspond at least in some aspects to, for example, a communication device, such as WAN transceiver 204, as discussed herein. A module for retrieving and sending 604 may correspond at least in some aspects to, for example, a processing system, such as processor 210 and/or wireless-based positioning module 216, and a communication device, such as WAN transceiver 204, as discussed herein. A module for performing and sending 606 may correspond at least in some aspects to, for example, a processing system, such as processor 210 and/or wireless-based positioning module 216, and a communication device, such as WAN transceiver 204, as discussed herein.

The functionality of the modules of FIG. 6 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 6, as well as other components and functions described herein, may be implemented using any suitable means. Such means also may be implemented, at least in part, using corresponding structure as taught herein. For example, the components described above in conjunction with the “module for” components of FIG. 6 also may correspond to similarly designated “means for” functionality. Thus, in some aspects one or more of such means may be implemented using one or more of processor components, integrated circuits, or other suitable structure as taught herein. More specifically, means for performing 502 of FIG. 5 can include the WAN transceiver 204 or similar communication device, means for performing 504 of FIG. 5 can include the processor 210 or similar processing system, means for performing 506 of FIG. 5 can include the processor 210 or similar processing system, and means for performing 508 of FIG. 5 can include the processor 210 or similar processing system. It is understood that, in some implementations, 506 or 508 may represent alternative processes based on whether or not an indicator indicates previous position measure for the cell are valid, and as such, means for determining which of 506 or 508 to perform can include the processor 210 or similar processing system.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a compact disc (CD)-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray® disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method for optimizing performance of positioning measurements, comprising:
detecting, by a wireless mobile device, movement of the wireless mobile device; and
in response to detecting the movement of the wireless mobile device, for each cell of a plurality of cells of a cellular network having an entry in a memory of the wireless mobile device:
comparing, by the wireless mobile device, the detected movement of the wireless mobile device to a measurements-valid threshold for the cell, and
in response to the comparison indicating that the movement of the wireless mobile device exceeds the measurements-valid threshold, updating, by the wireless mobile device, an indicator to indicate that previous positioning measurements for the cell are invalid;
receiving, at the wireless mobile device, a positioning measurements request indicating the plurality of cells to be measured by the wireless mobile device; and
for the each cell having the entry in the memory of the wireless mobile device:
based on the indicator indicating that the previous positioning measurements for the cell are valid, retrieving, by the wireless mobile device, the previous positioning measurements for the cell from the memory of the wireless mobile device and sending the previous positioning measurements for the cell to a location server; and
based on the indicator indicating that the previous positioning measurements for the cell are invalid, performing, by the wireless mobile device, new positioning measurements for the cell and sending the new positioning measurements for the cell to the location server.

2. The method of claim 1, further comprising, for the each cell of the plurality of cells having the entry in the memory of the wireless mobile device:
after calculating the new positioning measurements for the cell, storing, by the wireless mobile device, the new positioning measurements for the cell in the memory and updating the indicator to indicate that the new positioning measurements for the cell are valid.

3. (canceled)

4. The method of claim 1, wherein the movement of the wireless mobile device is detected by one or more motion sensors of the wireless mobile device.

5. The method of claim 4, wherein the one or more motion sensors comprise one or more accelerometers, one or more gyroscopes, or any combination thereof.

6. The method of claim 1, wherein the measurements-valid threshold for the cell is a function of signal to noise ratio (SNR), signal to interference and noise ratio (SINR), received signal strength indication (RSSI), reference signal received quality (RSRQ), or reference signal received power (RSRP) of positioning measurements performed by the wireless mobile device.

7. The method of claim 6, wherein the function comprises a change in the SNR, SINR, RSSI, RSRQ, or RSRP greater than a signal strength threshold.

8. The method of claim 1, wherein the new positioning measurements for the cell comprise positioning reference signal (PRS) measurements.

9. The method of claim 8, wherein the PRS measurements are based on positioning reference signals transmitted by base stations within wireless communication range of the wireless mobile device.

10. The method of claim 1, further comprising:
receiving, at the wireless mobile device, positioning assistance data from the location server, the positioning assistance data including information about the plurality of cells.

11. The method of claim 10, wherein the new positioning measurements for the cell are performed based on stored information for the cell, and
wherein the stored information for the cell is received in the positioning assistance data.

12. The method of claim 1, wherein the indicator comprises a valid/invalid bit, a table entry, or a registry entry.

13. The method of claim 1, wherein the wireless mobile device sends previous positioning measurements to the location server for a first subset of the plurality of cells and performs new positioning measurements for a second subset of the plurality of cells.

14. The method of claim 1, wherein the wireless mobile device comprises a wearable device, a cellular telephone, a tablet computer, or an Internet of Things (IoT) device.

15. An apparatus for optimizing performance of positioning measurements, comprising:
a transceiver of a wireless mobile device configured to receive a positioning measurements request indicating a plurality of cells of a cellular network to be measured by the wireless mobile device; and
at least one processor configured to, for each cell of the plurality of cells having an entry in a memory of the wireless mobile device:
detect movement of the wireless mobile device, and, in response to detection of the movement of the wireless mobile device:
compare the detected movement of the wireless mobile device to a measurements-valid threshold for the cell, and
update, in response to the comparison indicating that the movement of the wireless mobile device exceeds the measurements-valid threshold, an indicator to indicate that previous positioning measurements for the cell are invalid;
retrieve, in response to the positioning measurements request and based on an indicator indicating that the previous positioning measurements for the cell are valid, the previous positioning measurements for the cell from the memory of the wireless mobile device and send the previous positioning measurements for the cell to a location server; and
perform, in response to the positioning measurements request and based on the indicator indicating that the previous positioning measurements for the cell are invalid, new positioning measurements for the cell and send the new positioning measurements for the cell to the location server.

16. The apparatus of claim 15, wherein the at least one processor is further configured to, for the each cell of the plurality of cells having the entry in the memory of the wireless mobile device:
store, after calculating the new positioning measurements for the cell, the new positioning measurements for the cell in the memory and update the indicator to indicate that the new positioning measurements for the cell are valid.

17. (canceled)

18. The apparatus of claim 15, wherein the movement of the wireless mobile device is detected by one or more motion sensors of the wireless mobile device.

19. The apparatus of claim 18, wherein the one or more motion sensors comprise one or more accelerometers, one or more gyroscopes, or any combination thereof.

20. The apparatus of claim 15, wherein the measurements-valid threshold for the cell is a function of signal to noise ratio (SNR), signal to interference and noise ratio (SINR), received signal strength indication (RSSI), reference signal received quality (RSRQ), or reference signal received power (RSRP) of positioning measurements performed by the wireless mobile device.

21. The apparatus of claim 20, wherein the function comprises a change in the SNR, SINR, RSSI, RSRQ, or RSRP greater than a signal strength threshold.

22. The apparatus of claim 15, wherein the new positioning measurements for the cell comprise positioning reference signal (PRS) measurements.

23. The apparatus of claim 22, wherein the PRS measurements are based on positioning reference signals transmitted by base stations within wireless communication range of the wireless mobile device.

24. The apparatus of claim 15, wherein the transceiver is further configured to:
receive positioning assistance data from the location server, the positioning assistance data including information about the plurality of cells.

25. The apparatus of claim 24, wherein the new positioning measurements for the cell are performed based on stored information for the cell, and
wherein the stored information for the cell is received in the positioning assistance data.

26. The apparatus of claim 15, wherein the indicator comprises a valid/invalid bit, a table entry, or a registry entry.

27. The apparatus of claim 15, wherein the wireless mobile device sends previous positioning measurements to the location server for a first subset of the plurality of cells and performs new positioning measurements for a second subset of the plurality of cells.

28. The apparatus of claim 15, wherein the wireless mobile device comprises a wearable device, a cellular telephone, a tablet computer, or a Internet of Things (IoT) device.

29. A non-transitory computer-readable medium storing computer-executable instructions for optimizing performance of positioning measurements, the computer-executable instructions comprising:
at least one instruction instructing a wireless mobile device to receive a positioning measurements request indicating a plurality of cells of a cellular network to be measured by the wireless mobile device; and
at least one instruction instructing the wireless mobile device to, for each cell of the plurality of cells having an entry in a memory of the wireless mobile device:
detect movement of the wireless mobile device, and, in response to detection of the movement of the wireless mobile device:
compare the detected movement of the wireless mobile device to a measurements-valid threshold for the cell, and
update, in response to the comparison indicating that the movement of the wireless mobile device exceeds the measurements-valid threshold, an indicator to indicate that previous positioning measurements for the cell are invalid;
in response to the positioning measurements request and based on an indicator indicating that the previous positioning measurements for the cell are valid, retrieve the previous positioning measurements for the cell from the memory of the wireless mobile device and send sending the previous positioning measurements for the cell to a location server; and
in response to the positioning measurements request and based on the indicator indicating that the previous positioning measurements for the cell are invalid, perform new positioning measurements for the cell and send the new positioning measurements for the cell to the location server.

30. An apparatus for optimizing performance of positioning measurements, comprising:
means for:
detecting, by a wireless mobile device, movement of the wireless mobile device, and in response to detecting the movement of the wireless mobile device, for each cell of a plurality of cells of a cellular network having an entry in a memory of the wireless mobile device:
comparing, by the wireless mobile device, the detected movement of the wireless mobile device to a measurements-valid threshold for the cell, and
in response to the comparison indicating that the movement of the wireless mobile device exceeds the measurements-valid threshold, updating, by the wireless mobile device, an indicator to indicate that previous positioning measurements for the cell are invalid;
means for receiving, at the wireless mobile device, a positioning measurements request indicating the plurality of cells to be measured by the wireless mobile device; and
means for:
for the each cell of the plurality of cells having the entry in the memory of the wireless mobile device:
retrieving, based on the indicator indicating that the previous positioning measurements for the cell are valid, the previous positioning measurements for the cell from the memory of the wireless mobile device and sending the previous positioning measurements for the cell to a location server; and
performing, based on the indicator indicating that the previous positioning measurements for the cell are invalid, new positioning measurements for the cell and sending the new positioning measurements for the cell to the location server.
